(19) United States
(12) Patent Application Publication
(10) Pub. No.: US 2012/0208418 A1
(43) Pub. Date: Aug. 16, 2012

(54) SYNTHETIC LEATHER

(76) Inventors: Moon-Ki Yea, Ulsan (KR); Su-Hyeong Yun, Busan (KR)

(21) Appl. No.: 13/504,066

(22) PCT Filed: Oct. 26, 2010
(86) PCT No.: PCT/KR2010/007375

§ 371 Date: Apr. 25, 2012

(30) Foreign Application Priority Data
Nov. 7, 2009 (KR) 1020090110636

(51) Int. Cl. D04B 1/18; B32B 37/00; B60N 2/58; D04B 1/00

(52) U.S. Cl. 442/306; 442/304; 156/60; 297/219.1

(57) ABSTRACT

Disclosed is synthetic leather, which includes and fabricated by laminating: a) a sheet made of PVC or polyurethane; b) a knit fabric having core yarn inserted between fabric weaves, a knit fabric knitted together with elastic yarn, or a knit fabric which has core yam inserted between fabric weaves and is knitted together with elastic yam. It is possible to provide synthetic leather, which replaces synthetic leather fabricated by laminating a PVC resin surface layer, a polyurethane foam cushion layer and a fabric layer using flame lamination process to fundamentally remove defect such as combustion gas and residual catalyst generated in flame lamination process of polyurethane foam and fabric and discoloration by monomer, improve rumples and twists generated in a sewed portion after sewing, and allow shortening of delivery date through shortening of process and removal of loss on process.

### TECHNICAL FIELD

The present invention relates to synthetic leather, and more particularly, to synthetic leather, which replaces synthetic leather fabricated by laminating a PVC resin surface layer, a polyurethane foam cushion layer and a fabric layer using flame lamination process to fundamentally remove defect such as combustion gas and residual catalyst generated in flame lamination process of polyurethane foam and fabric and discoloration by monomer, improve rumples and twists generated in a sewed portion after sewing, and allow shortening of delivery time through shortening of process and removal of loss on process.

### BACKGROUND ART

Synthetic leather for a vehicle seat cover is a produce fabricated by laminating PVC or polyurethane sheet and textile or knit fabric and then performing a surface treatment suitable for a use, and is widely used as a replacement of natural leather.

The synthetic leather for a vehicle seat cover is generally fabricated by flame laminating 3T˜7T polyurethane sheet and fabric in order to allow easy sewing and cushioning property.

FIG. 1 is a schematic view showing conventional synthetic leather for a vehicle seat cover fabricated by laminating a PVC resin surface layer, a polyurethane foam cushion layer and a fabric layer using a flame lamination process.

The synthetic leather of FIG. 1 causes rumples, twist and the like a sewed portion upon sewing, a quality problem of combustion gas of the polyurethane foam or residual catalyst generated in the flame lamination process or discoloration of the PVC resin surface layer due to discoloration of polyurethane foam itself, and also has problems of prolonged delivery date and large loss on process since sewing process is performed after fabrication of the PVC resin surface layer and flame lamination process of polyurethane foam and the fabric.

Particularly, the synthetic leather for a vehicle seat cover requires higher mechanical strength and light resisting/thermal resisting stability as compared with synthetic leather used in conventional furniture or and thus tends to have high hardness, thereby causing strong rumples in the vicinity of the sewed portion.

### DISCLOSURE OF INVENTION

### Technical Problem seat cover, which has less rumples in the sewed portion and can fundamentally prevent generation of causes of defect and discoloration of the product.

### Solution to Problem

It is an object of the present invention to provide synthetic leather, which replaces synthetic leather fabricated by laminating a PVC resin surface layer, a polyurethane foam cushion layer and a fabric layer using flame lamination process to fundamentally remove defect such as combustion gas and residual catalyst generated in flame lamination process of polyurethane foam and fabric and discoloration by monomer, improve rumples and twists generated in a sewed portion after sewing, and allow shortening of delivery date through shortening of process and removal of loss on process.

Also, it is another object of the present invention to provide a vehicle seat cover made of the synthetic leather.

The above and other objects of the present invention will become apparent from a reading of the following description which sets forth preferred embodiments thereof.

To solve the problem, the present invention provides synthetic leather, which includes a) a sheet made of PVC or polyurethane; b) a knit fabric having core yarn inserted between fabric weaves, a knit fabric knitted together with elastic yarn, or a knit fabric which has core yarn inserted between fabric weaves and is knitted together with elastic yarn.

Also, the present invention provides a vehicle seat cover made of the synthetic leather.

In accordance with the present invention, it is possible to provide synthetic leather, which replaces synthetic leather fabricated by laminating a PVC resin surface layer, a polyurethane foam cushion layer and a fabric layer using flame lamination process to fundamentally remove defect such as combustion gas and residual catalyst generated in flame lamination process of polyurethane foam and fabric and discoloration by monomer, improve rumples and twists generated in a sewed portion after sewing, and allow shortening of delivery date through shortening of process and removal of loss on process.

### BRIEF DESCRIPTION OF DRAWINGS

FIG. 1 is a schematic sectional view showing conventional synthetic leather for a vehicle seat cover.

FIG. 2 is a schematic sectional view illustrating an example of synthetic leather in accordance with the present invention having a knit fabric in which a core yarn is inserted between fabric weaves.

FIG. 3 is a schematic sectional view illustrating an example of synthetic leather in accordance with the present invention having a knit fabric in which an elastic yarn is knitted together.

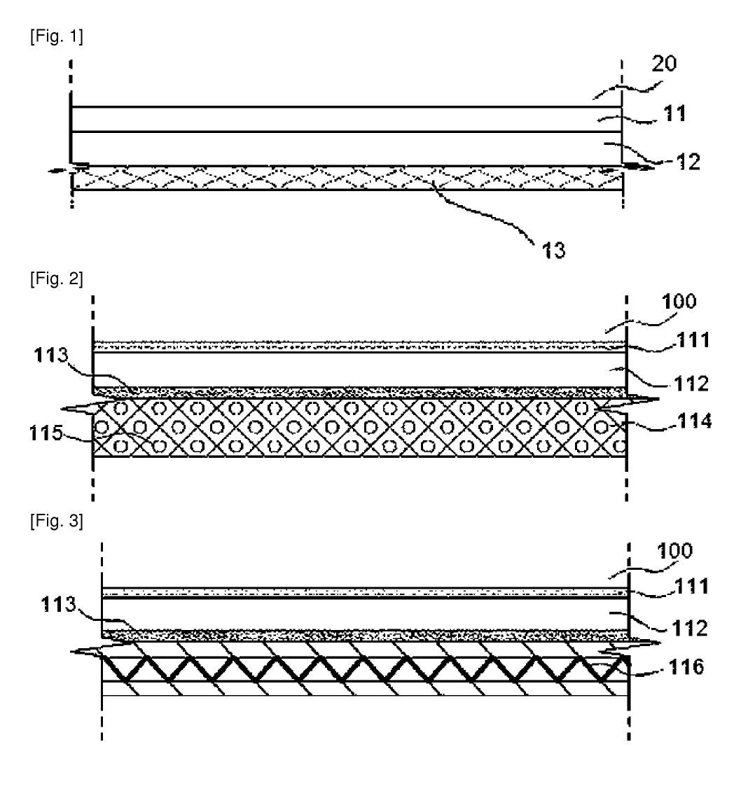

### BRIEF DESCRIPTION OF MAIN ELEMENTS

11: PVC resin surface layer 12: polyurethane foam cushion layer

13: fabric layer 20: conventional synthetic leather

100: synthetic leather of the present invention 111: surface treatment layer

112: sheet made of PVC 113: bonding layer

114: knit fabric 115: core yarn

116: elastic yarn

### MODE FOR THE INVENTION

Hereinafter, an embodiment of the present invention will be described in detail with reference to accompanying drawings.

Synthetic leather of the present invention is fabricated by laminating a) a sheet made of PVC or polyurethane; b) a knit fabric having core yarn inserted between fabric weaves, a knit fabric knitted together with elastic yarn, or a knit fabric which has core yarn inserted between fabric weaves and is knitted together with elastic yarn.

The sheet made of PVC may contain 50 to 140 parts by weight, preferably 80 to 120 parts by weight of a plasticizer for 100 parts by weight of PVC, and in this range the PVC sheet has enough softness and rumples in sewed portion upon sewing are reduced.

The PVC or polyurethane sheet may be, to meet quality required by a vehicle manufacturer, further added with one or more selected from the group consisting of various pigments, emulsifiers, heat stabilizers, photostabilizers, flame retardants, antioxidants, lubricants and antistatic agents.

The knit fabric having core yarn inserted between fabric weaves, the knit fabric knitted together with elastic yarn, or the a knit fabric which has core yarn inserted between fabric weaves and is knitted together with elastic yarn gives excellent cushioning property to the fabricated synthetic leather.

The knit fabric means the fabric of fabric weaves fabricated using a circular knitting machine, a warp knitting machine or a flat knitting machine.

The core yarn means yarn inserted in weaves of knit fabric as core and is preferably polyester yarn which is thicker than the yarn constructing the knit fabric.

The core yarn keeps volume even under a condition where there is applied pressure on process (embossing or laminating) of synthetic leather, and allows volume and thickness of the final product of synthetic leather through adjustment of the thickness of the core yarn.

The knit fabric knitted together with elastic yarn may be one where the elastic yarn is knitted in zigzag in a longitudinal direction of the knit fabric, preferably one where the elastic yarn is knitted in a manner connecting upper and lower layers of dual-layered knit fabric alternately, in which case the elastic yarn supports the fabric to enhance volume of the fabric up.

The elastic yarn has higher elasticity than the yarn constructing the knit fabric, and is preferably a polyester yarn which is thicker than other yarn of the knit fabric and has less number of filaments, which provides excellent volume to final product of synthetic leather.

It is preferred that the lamination is performed by use of bond or thermocompression.

The bond is preferably polyurethane or PVC based sol type bond. The thermocompression process is preferably performed by preliminarily thermocompressing the sheet made of PVC or polyurethane with the knit fabric using latent heat generated upon fabrication of the PVC or polyurethane sheet and then secondarily thermocompressing them in subsequent foaming and embossing process using heat applied under the foaming and embossing condition, and in this case, the fabric is impregnated into the PVC or polyurethane sheet and thus splitting resistance is notably increased.

If necessary, the synthetic leather may further include a surface treatment layer formed over the PVC or polyurethane sheet.

The surface treatment layer is a coat which is formed by a predetermined surface treatment in order to meet long-term reliability such as light resistance and weather resistance and surface frictional coefficient that determines feeling of touching surface, required by a vehicle seat cover, and material and method therefor are not particularly limited provided that they applicable to the surface treatment layer of a synthetic leather.

Examples of the synthetic leather in accordance with the present invention are shown in FIGS. 2 and 3, and the synthetic leather 100 of FIGS. 2 and 3 includes a surface treatment layer 111, a sheet 112 made of PVC, a bonding layer 113, a knit fabric 113, a core yarn 115 and an elastic yarn 116.

A vehicle seat cover of the present invention is made of the synthetic leather.

Practical and presently preferred embodiments of the present invention are illustrative as shown in the following Examples. However, it will be appreciated that those skilled in the art, on consideration of this disclosure, may make modifications and improvements within the spirit and scope of the present invention.

### EXAMPLES

### Example 1

Synthetic leather in accordance with the present invention having a thickness of 0.8 to 1.3 mm was fabricated by laminating a knit fabric into which a 300 D high elastic yarn made of polyester material is inserted and a soft sheet made of PVC using a polyurethane based bond.

The fabricated synthetic leather was subjected to sewing and sheet covering process, thereby completing a vehicle sheet cover.

The PVC sheet used has a thickness of 0.3 to 0.8 mm and is fabricated with inclusion of 80 to 120 parts by weight of a plasticizer for 100 parts by weight of PVC, and the knit fabric used has a basis weight of 300 to 330 g/m² and is a knit fabric of which core yarn applied is a thick and stiff polyester yarn having less number of filaments as compared with the knitted yarn.

### Example 2

The same as Example 1, except for using a knit fabric having a basis weight of 390 g/m² kitted together with a 150 D polyester elastic yarn which is thick and stiff and has less number of filaments as compared with the knit yarn kitted together, instead of the knit fabric into which a core yarn (polyester yarn) is inserted.

### EXPERIMENTAL EXAMPLE

From the result of inspection of the synthetic leather and the vehicle sheet cover fabricated in Examples 1 and 2, it could be found that the sewing process is performed more conveniently and rumples and twist of the fabricated vehicle seat cover are significantly reduced.

While the present invention has been described with respect to the specific embodiments, it will be apparent to those skilled in the art that various changes and modifications may be made without departing from the spirit and scope of the invention as defined in the following claims.

1. Synthetic leather, comprising and fabricated by laminating: a) a sheet made of PVC or polyurethane; b) a knit fabric having core yarn inserted between fabric weaves, a knit fabric knitted together with elastic yarn, or a knit fabric which has core yarn inserted between fabric weaves and is knitted together with elastic yarn.

2. The synthetic leather of claim 1, wherein the lamination is performed by use of a bond.

3. The synthetic leather of claim 1, wherein the PVC sheet contains 50 to 140 parts by weight of a plasticizer for 100 parts by total weight of PVC.

4. The synthetic leather of claim 1, wherein the core yarn is knitted in zigzag in a longitudinal direction of the knit fabric.

5. The synthetic leather of claim 1, wherein the core yarn and the elastic yarn are a polyester yarn which is thicker than other yarn of the knit fabric and has less number of filaments, respectively.

6. A vehicle seat cover made of the synthetic leather of claim 1.

7. A method for fabricating synthetic leather, comprising: laminating: a) a sheet made of PVC or polyurethane; b) a knit fabric having core yarn inserted between fabric weaves, a knit fabric knitted together with elastic yarn, or a knit fabric which has core yarn inserted between fabric weaves and is knitted together with elastic yarn, wherein the lamination is performed by use of a bond or thermocompression process.

8. A vehicle seat cover made of the synthetic leather of claim 2.

9. A vehicle seat cover made of the synthetic leather of claim 3.

10. A vehicle seat cover made of the synthetic leather of claim 4.

11. A vehicle seat cover made of the synthetic leather of claim 5.
